(19) United States
(12) Patent Application Publication
(10) Pub. No.: US 2014/0089813 A1
(43) Pub. Date: Mar. 27, 2014

(54) RANKING OF USER FEEDBACK BASED ON USER INPUT DEVICE TRACKING

(71) Applicants: Darius Vahdat Pajouh, Hagen (DE); Alexander Runde, Hagen (DE)

(72) Inventors: Darius Vahdat Pajouh, Hagen (DE); Alexander Runde, Hagen (DE)

(21) Appl. No.: 13/624,445

(22) Filed: Sep. 21, 2012

(51) Int. Cl. G06F 3/01

(52) U.S. Cl. 715/748

(57) ABSTRACT

Methods, systems, and apparatus, including computer programs encoded on a computer storage medium for obtaining first position information of a first user interaction with a multimedia content item that is presented at a first time to the first user in a presentation area on a first computer device; obtaining, in response to obtaining the first position information, second position information of a second user interaction with the multimedia content item that was presented at a second time to a second user in a presentation area on a second computer device, the second time occurring before the first time; calculating a correlation score that is indicative of the relatedness of the second user interaction to the first user interaction; and in response to the correlation score meeting a threshold value, providing a first data set provided by the second user and associated with the first user interaction to the first user.

### BACKGROUND

High bandwidth internet connections allow distributing multimedia content all over the world. There exist numerous platforms to allow for user interaction with multimedia content. For instance, a video file can be made available via a browser based video player. Users watching the video file in an internet browser can comment on the video file's content. These comments are being added to the video file and made available to future watchers of the video file.

### SUMMARY

The devices and methods described relate to improved presentation and user interaction in online and offline applications for distributing multimedia digital content.

In a first aspect, a computer-implemented method includes obtaining first position information of a first user interaction with a multimedia content item that is presented at a first time to the first user in a presentation area on a first computer device, the first position information indicating the position where the first user interaction took place in the presentation area of the multimedia content item, obtaining, in response to obtaining the first position information, second position information of a second user interaction with the multimedia content item that was presented at a second time to a second user in a presentation area on a second computer device, the second time occurring before the first time, the second position information indicating the position where the second user interaction took place in the presentation area of the multimedia content item, calculating a correlation score that is indicative of the relatedness of the second user interaction to the first user interaction using the first position information and the second position information, in response to the correlation score meeting a threshold value, providing a first data set provided by the second user and associated with the first user interaction to the first user.

In a second aspect, a computer-implemented method includes presenting a multimedia content item to a first user that is presented at a first time to the first user in a presentation area on a first computer device, monitoring first position information of a first user interaction with the multimedia content item, the first position information indicating the position where the first user interaction took place in the presentation area of the multimedia content item, providing the first position information to a computer system, obtaining a first data set provided by a second user and associated with a second user interaction with the multimedia content item that was presented at a second time to the second user in a presentation area on a second computer device, the second time occurring before the first time, the first data set being selected using a first correlation score that is indicative of the relatedness of the second user interaction to the first user interaction using the first position information and second position information, the second position information indicating the position where the second user interaction took place in the presentation area of the multimedia content item. The method can further include presenting the first data set to the second user while presenting the multimedia content item to the second user.

### BRIEF DESCRIPTION OF THE DRAWINGS

FIG. 1 shows a schematic screenshot of an application for presenting a multimedia content item to a user during presentation of the multimedia content item.

FIG. 2 shows a schematic screenshot of an application for presenting a multimedia content item to a user after a user interaction occurred.

FIG. 3 shows a schematic screenshot of an application for presenting a multimedia content item to a user during submission of user feedback.

FIG. 4 shows a schematic screenshot of an application for creating a multimedia content item.

FIGS. 5a to 5d illustrate different ways to determine a correlation factor of two user interactions.

FIGS. 6a and 6b illustrate different ways to determine a correlation factor of two user interactions.

Like reference numbers and designations in the various drawings indicate like elements.

### DETAILED DESCRIPTION

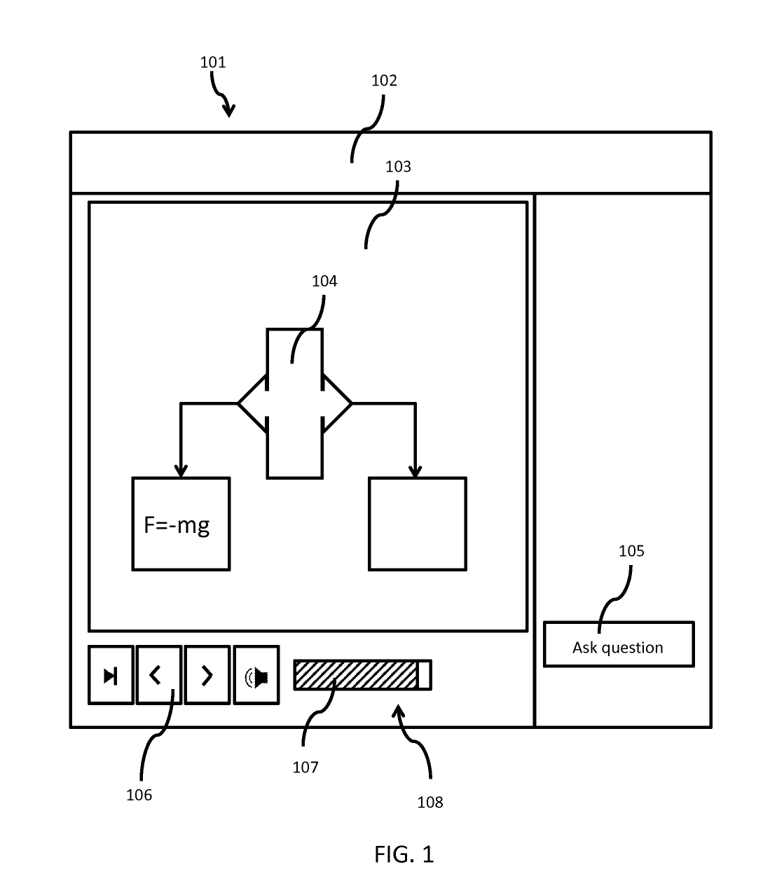

FIG. 1 shows a screenshot of an application for presenting a multimedia content item to a user. A multimedia content item includes audio data, video and/or image data. Moreover, the multimedia content item can include data characterizing a track of a pointer and/or input device separate from the video and/or image data. During presentation of the multimedia content item, this data characterizing the track of the pointer and/or input device can be used to render a graphic representation of the pointer device and present it on top of the video and/or image data. For example, in a presentation including a slide show and corresponding audio track, the data characterizing a track of a pointer device can include a track of the mouse or pointer the author has used to guide a listener through the slides. In other examples, if the multimedia content item includes video data, the track of the pointer device can also be part of the video data. Keeping the data characterizing a track of a pointer device separate from the video and/or image data can be advantageous as it simplifies implementing different functions for improving user interaction, as will be discussed below.

The image data can include a series of images in a predetermined order (e.g., a slide show of a presentation). In one example, the multimedia content item includes a slide show of a presentation and a corresponding audio track. If the multimedia content item includes a series of images (e.g., a slide show of a presentation) for presentation to a user, it can include timing data determining, for each image, a period of time during which the respective image is presented to a user. Alternatively, the period of time during which the respective image is presented to a user can be determined based on a user input. In addition, a multimedia content item can include text data.

In one example, the multimedia content item is a web page (which can include still and animated images, videos and text). In this example, the application for presenting a multimedia content item to a user can be a web browser. In other examples, the multimedia content item is the content of a display screen presented to a user during operation of a computer device (e.g., a graphical user interface of an operation system). In this example, the application for presenting a multimedia content item to a user can be a program executed on the computer device.

The application for presenting the multimedia content item can be executed in different environments. In one example, the application is executed in a browser environment (for instance, in a web browser for browsing the internet). In this example, the user navigates to a web page which is linked to the application for presenting the multimedia content item. For example, upon entering a network address of the web page which is linked to the application for presenting the multimedia content item, the graphical user interface 101 as shown in FIG. 1 can be launched. The web page can have a unique address for a particular multimedia content item (e.g., a slide show of a university course in mechanics).

However, the application for presenting the multimedia content item can also be executed in on-line environments other than browser environments and in off-line environments.

The graphical user interface 101 of the application for presenting the multimedia content item includes a first area for displaying video or image data 103 included in the multimedia content item. In the exemplary screenshot of FIG. 1, a slide of a presentation is presented to a user. One or more control elements 106 allow the user to control the presentation of the multimedia content item. For example, the control elements can include a start/stop control element or control elements for moving one slide forward or backward in the presentation. If the multimedia content item includes video data, the control elements can include control elements for controlling fast forward/backward, stop and play operations.

In the example of FIG. 1 a progress bar 107 shows the progress of the presentation of the multimedia content item to the user. The graphical user interface 101 of the application for presenting a multimedia content item can include additional control elements and input and output fields to control different functions of the application for presenting a multimedia content item and for presentation of information to the user.

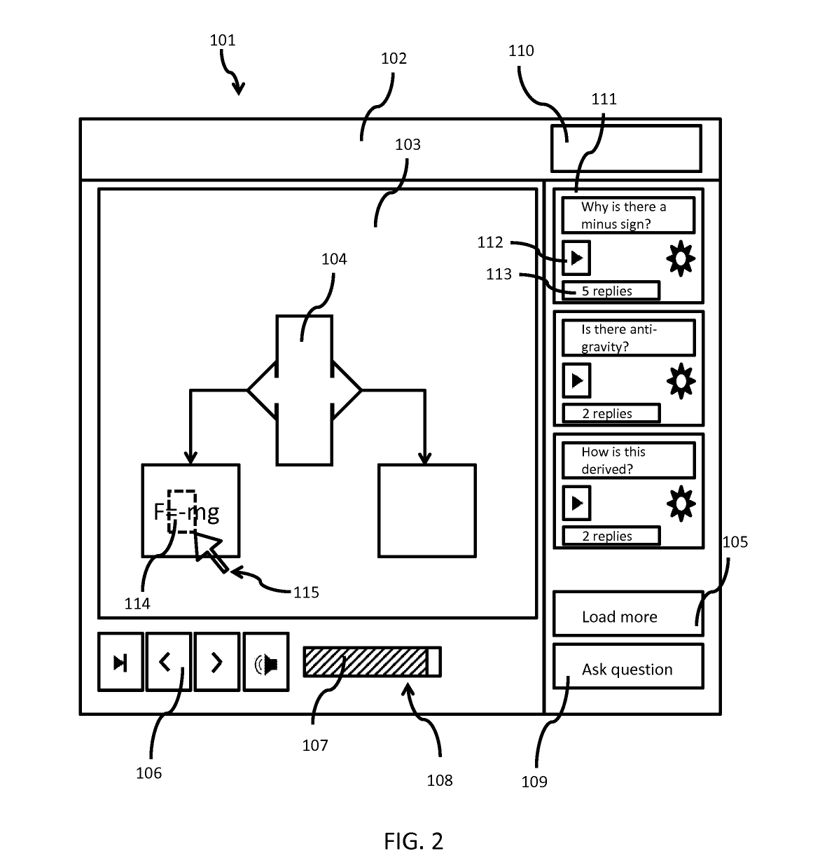

At a predetermined point in time during presentation of the multimedia content item, the user, e.g., has a question with respect to a certain aspect of the multimedia content item or wants to submit a comment. For example, as shown in FIG. 2, a slide of a presentation shows a mathematical formula and the user has a question regarding this formula. Then, she/he moves a cursor of a pointer device (e.g., a computer mouse) over a portion of the first area for displaying video or image data 103. In the example of FIG. 2, the user creates by the pointer device a rectangular selection of an area enclosing the portion of the presentation she/he wishes to comment on. For instance, she/he marks the upper left corner of the rectangular selection by pressing a button of the pointer device, keeps the button pressed and marks the lower right corner of the rectangular selection 114 by releasing the button of the pointer device and hereby define the rectangular selection. This is an example of a user interaction with the multimedia content item.

However, a user interaction is not limited to the above described example. In general, by virtue of a user interaction the user selects a subset of a presentation area the image or video content of the multimedia content item is being presented in. The subset can include a point, an area or a 2D or 3D shape (for example, in FIG. 2, the user interaction selects the rectangular selection 114). An area can be a rectangle or an ellipsoid.

In further examples, a user interaction includes a predetermined movement of a pointer in the presentation area of the graphical user interface and/or an action of an input device to select a subset of the presentation area. For example, a predetermined movement of a pointer in the presentation area of the multimedia content item can be hovering over an element presented in the presentation area of the multimedia content item or moving the pointer along a predetermined path (e.g., “drawing” a line under an element presented in the presentation area). Additionally, a user interaction can be a predetermined movement of an input device in the presentation area in combination with a user input (e.g., moving a cursor of a computer mouse from a first point to a second point while pressing a mouse button).

The pointer and/or input devices for graphical user interfaces enable a user to move a pointer over the graphical user interface including the in the presentation area, and optionally the pointer and/or input devices have elements to receive a user input (e.g., pressing a button). For example, a pointer and/or input devices can be computer mouse, a trackball, an input device for a touchscreen, a keyboard or an eye tracking system. The pointer and/or input device can be connected directly to the computer device presenting the multimedia content item to the user (e.g., a computer mouse). Alternatively, actions of the pointer and/or input device can be digitized and transmitted to the computer device presenting the multimedia content item to the user (e.g., a camera capturing the movement of a laser pointer). In the example of FIG. 2, the input device is a computer mouse enabling the user to navigate a cursor over a portion of the formula displayed in the slide show. The actual selection of the subset of a presentation area the image or video content of the multimedia content item is being presented in includes pressing and releasing the mouse buttons.

In other examples, the video and/or image data of the multimedia content item is presented on a device having a touch screen. In this example, the pointer and/or input device can be a finger of the user or another pointed object. Then, the user interaction can include selecting the subset of the presentation area the image or video content of the multimedia content item is being presented in directly by interacting with the touch screen. In the example of FIG. 2, the user could mark the upper left corner of the rectangular selection 114 by his finger, sliding his finger over the surface of the touch screen and marking the lower right corner of the rectangular selection by removing her/his finger from the touch screen.

In other examples, a predetermined “short-cut” selects the subset of the presentation area the image or video content of the multimedia content item is being presented in. For example, the user can navigate a pointer (e.g., a cursor) of pointer and/or input device in the vicinity of the subset of the presentation area to be selected and then selects a predetermined area or shape in the presentation area (for example, a rectangle with predetermined side lengths).

The presentation of the multimedia content item to a user can include different presentation devices. In one example, a presentation device can be a display. However, a presentation device can also be a device for overlaying content over objects in the field of view of a user (e.g. devices for generating an “augmented reality”). In this situation, the “presentation area” is not a two dimensional surface, but rather a three dimensional scene the user looks at. Accordingly, a user interaction can also involve selecting portions of the presentation area not used for image or video data presentation. In these examples, the pointer and/or input devices can include the user's fingers or arms (e.g., for selecting the subset of the presentation area by pointing and/or gestures) or an eye tracking system (e.g., for selecting the subset of the presentation area by monitoring gaze direction and gaze duration).

After the user has selected subset of the presentation area the image or video content of the multimedia content item is being presented in (the rectangular selection 114 in FIG. 2), one or more additional items including user feedback are presented to a user. In the example depicted in FIG. 2, three comments of users to whom the multimedia content item was presented previously are presented. The content items 111 in FIG. 2 include a header with a short description of the user feedback, audio data captured by the respective previous user (e.g., an explanation why there is a minus sign in the formula depicted in FIG. 2) and information regarding a number of replies to the particular user feedback.

In the example of FIG. 2, the user can listen to the audio data captured by a previous user by pressing a play button 112 included in each additional item including user feedback. In addition a track of a pointer and/or input device in the first area for displaying video or image data 103 (the presentation area) recorded by the previous user synchronized with the audio data can be rendered. In one example, pressing the play button 112 stops the presentation of the multimedia content item and starts playing the audio data captured by the respective previous user. After the audio data captured by the respective previous user has been played, the presentation of the multimedia content item resumes.

In the example of FIG. 2 the user feedback includes audio data. However, the user feedback can also include image or video data provided by a previous user. In this example, pressing the play button 112 stops the presentation of the multimedia content item and starts presenting the image or video data provided by a previous user. Again, a track of a pointer and/or input device in the first area for displaying video or image data 103 (the presentation area) recorded by the previous user synchronized with the audio data can be rendered. After the image or video data provided by a previous user has been presented, the presentation of the multimedia content item resumes. In other examples, a previous user might also move through the images and or video data of the multimedia content item itself, record this action and provide it as user feedback. Then, pressing the play button 112 stops the presentation of the multimedia content item and starts presenting the portions of the images and or video data of the multimedia content item recorded by the previous user. For example, a previous user can explain why there is a minus sign in the formula presented on a certain slide of a presentation included in a multimedia content file by moving back to a previous slide and adding textual or audio explanations. She/he can record this action and provide it as a user feedback.

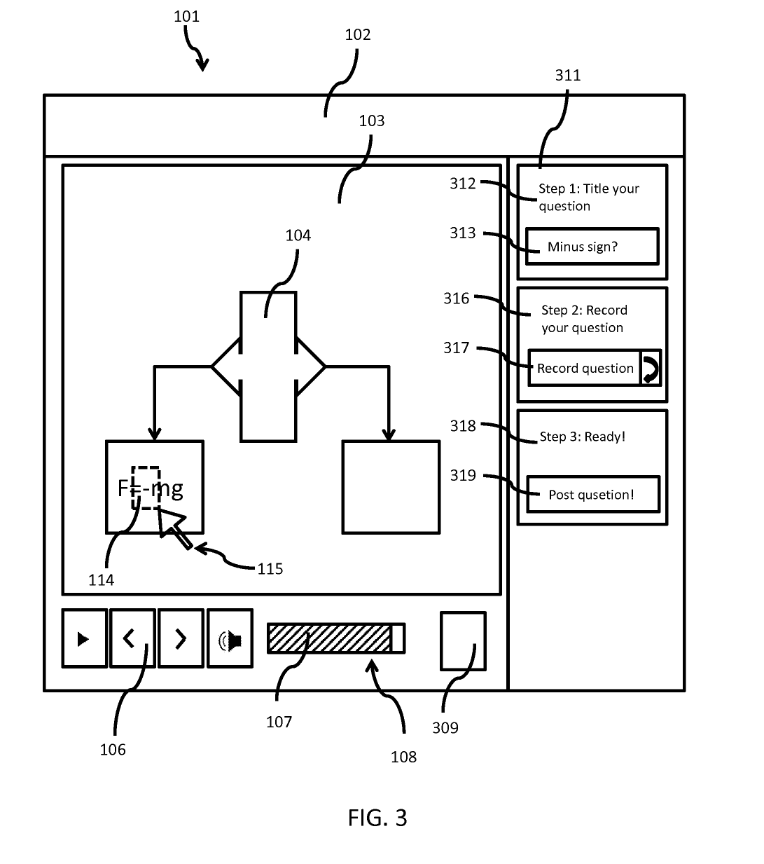

The graphical user interface 101 of the application for presenting a multimedia content item to a user can additionally include one or more of the following elements. A control element 105 can be provided for increasing or decreasing the number of additional items including user feedback presented to the user. A control element 109 can be provided to allow the user himself to submit user feedback (e.g., ask a question, give an explanation). Details of the process of submitting user feedback are explained in connection with FIG. 3. Different control elements can trigger actions related to a particular additional item including user feedback. For instance, replies to a particular additional item including user feedback can be presented upon pressing a respective control element 113.

FIG. 3 depicts a screenshot of an application for submitting a user feedback item for a multimedia content item. For example, the application can be launched upon pressing a control element 109 included in the graphical user interface of the application for presenting a multimedia content item to a user. The application for submitting a user feedback item for a multimedia content item can be integrated in the application for presenting a multimedia content item to a user. For example, the user can decide to submit user feedback during presentation of the multimedia content item. If she/he activates the respective control element 109, the presentation of the multimedia content item is stopped. The user can then input her/his user feedback. The user feedback is also associated with user interaction selecting a subset of the presentation area the image or video content of the multimedia content item is being presented in, as described above. Selecting the subset can be performed by the user as explained above. In the example of FIG. 3, the user has selected a rectangular area. The selection of the subset can be performed before or after the user has activated the control element 109 for submitting user feedback. For example, the user can select the subset of the presentation area the image or video content of the multimedia content item is being presented in, review the user feedback of previous users and then activate the control element control element 109 for submitting user feedback.

FIG. 3 shows an example of three elements 311 presented to a user after she/he has activated the control element control element 109 for submitting user feedback. In a first input field 313, the user can input a short title of her/his feedback (e.g., a question). In a second step, the user can record an audio file (e.g., after having activated a respective control element 317).

In addition, the user can record a track of a pointer and/or input device in the first area for displaying video or image data 103 (the presentation area).

After having recorded the audio file, the user can submit his user feedback (e.g., after having activated a submission control element 319).

As described above, the user can also submit images, video data or textual data with his user feedback. In the example of FIG. 3, a control element 309 for adding images or video data is provided in the graphical user interface (an audio file and/or a track of a pointer and/or input device in the first area for displaying video or image data 103 are recorded simultaneously). In other examples, the user can navigate through the image or video data of the multimedia content item by using control elements 106, record this action and submit is as user feedback. For example, the user can move back and forth through the slides of a presentation and can record this action (again, an audio file and/or a track of a pointer and/or input device in the first area for displaying video or image data 103 are recorded simultaneously). In other example, the user can change a zoom level of the presented multimedia content item or magnify predetermined portions of the multimedia content item and record these actions.

The submitted user feedback is ready to be presented as explained in the context of FIG. 2. The user feedback can be stored in the same data format as the multimedia content item, as described below.

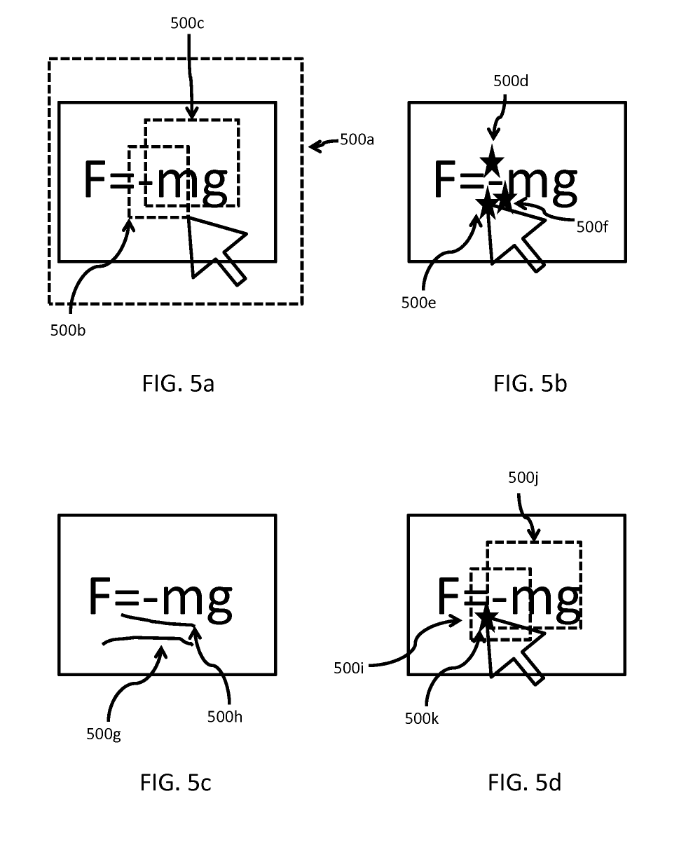

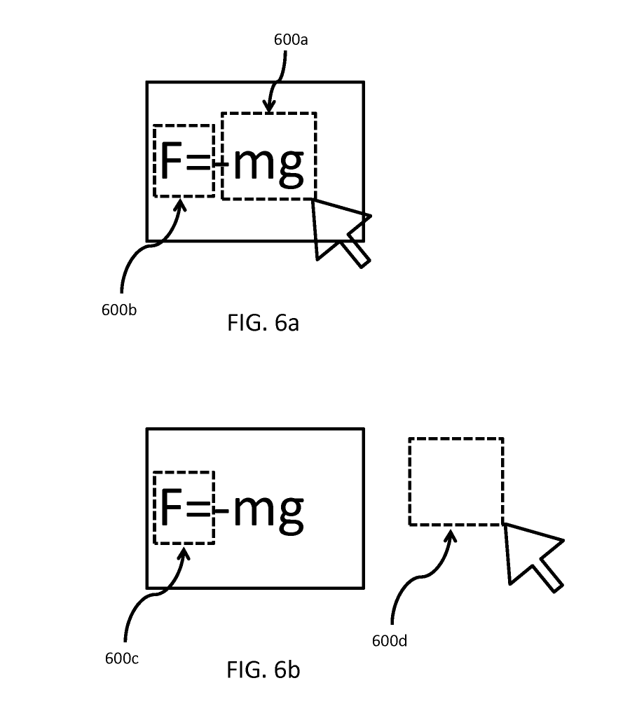

As explained above, each user feedback is associated with a user interaction of selecting a subset of the presentation area the image or video content of the multimedia content item is being presented in. It will be described in connection with FIGS. 5 and 6 that the associated user interactions can be used to select the additional items including user feedback presented to a user upon selecting a subset of the presentation area. During presentation of the additional content items including feedback, the associated user interactions are normally not visualized to the user. In some examples, the user interactions associated with the user feedback can be visualized to the user to whom the multimedia content tem is presented. For example, the selected subset of the presentation area can be visualized to the user when selecting the additional content items including feedback or hovering with a cursor of a pointer and/or input device over the additional content items.

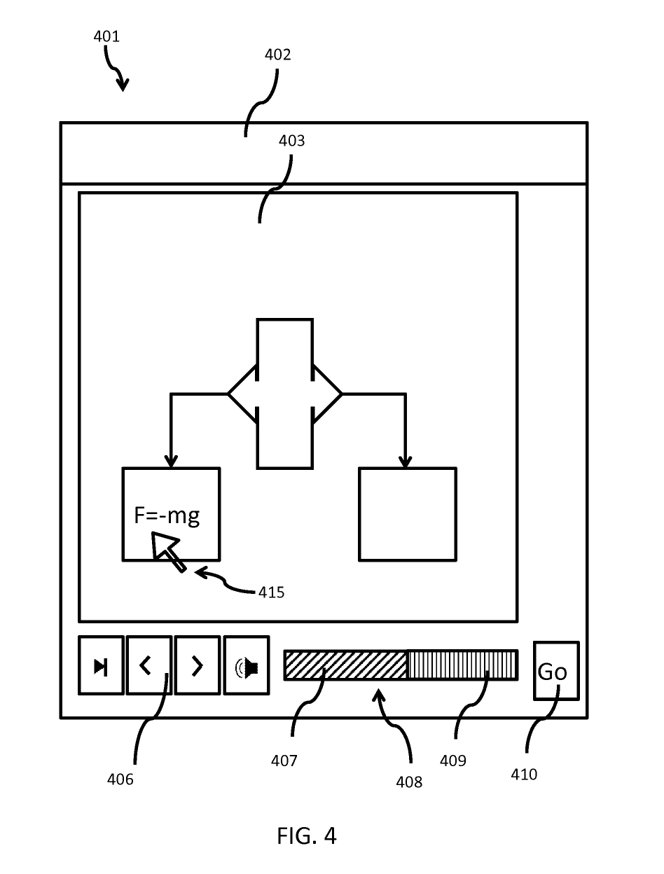

In FIG. 4, an application for creating a multimedia content item for presentation to a user is depicted. The application for creating the multimedia content item can also be configured to be executed in a browser environment.

In one example, the generation process includes submitting image and/or video data by an author of the multimedia content item. Then, during presentation of the image and/or video data, a track of a user interaction with the image and/or video data presented in the graphical user interface and an audio signal are recorded. For example, if the image and/or video data are a presentation, the author can navigate a cursor of a pointer and/or input device to point at different parts of the slides and in the same time give explanations (e.g., to create a multimedia content file including a lecture).

A first section 407 of a progress bar 408 indicates the length of this first portion of recorded data. In one example, the author can stop the recording by activating a control element 410 presented in the graphical user interface. Then, the author can resume recording again activating a control element 410 presented in the graphical user interface. In this situation, a second section 409 of the progress bar 408 indicates the length of a second portion of recorded data. This situation is depicted in FIG. 4.

The author can also use control elements 406 to move through the multimedia content item (e.g., move forward and backward in slides of a presentation) or start/stop a presentation of the multimedia content item.

The author can then manipulate the first and/or second sections 407, 409 of the progress bar to rearrange the first and second portions of recorded data. For example, the author can delete a section 407, 409 of the progress bar 408 (e.g., by activating a respective control element). In other examples, the author can change the order of the sections 407, 409 of the progress bar 408 by dragging and dropping a particular section 407, 409. The application for creating a multimedia content item for presentation to a user is configured to translate the interaction of the author with the progress bar sections 407, 409 into a respective action on the recoded data and the submitted image and/or video data. For example, deleting a section 407, 409 of the progress bar 408 can be translated into deleting the corresponding portion of recorded data. In other examples, dragging and dropping a particular section 407, 409 of the progress bar can change the order of the corresponding portions of recorded data.

In the context of FIG. 2, it was explained that the application for presenting the multimedia content item to a user is configured to present a number of additional items including user feedback. In the context of FIGS. 5 and 6 it will be explained how particular additional items including user feedback are selected by the application for presenting the multimedia content item.

As described above, the additional items including user feedback are presented in response to a user interaction with the multimedia content item to select a subset of the presentation area the image or video content of the multimedia content item is being presented in. In addition, also explained above, the additional items including user feedback are associated with a user interaction with the multimedia content item to select a subset of the presentation area the image or video content of the multimedia content item is being presented in as well.

The selection of the additional items including user feedback is based on a similarity of the user interaction carried out by the user during presentation of the multimedia content item and user interactions of the previous users who submitted user feedback. In order to determine the similarity of two user interactions, each user interaction is associated with position information. This position information indicates the position where a respective user interaction took place in the presentation area of the multimedia content item.

Position information can include one or more points in the presentation area of the multimedia content item. For example, if the presentation area is a two dimensional surface, the point can be characterized by a coordinate pair. If the presentation area is a three dimensional volume, the point can be characterized by a coordinate triplet.

In some examples, as described above, the user interactions selects a subset of the presentation area the image or video content being an area or a 2D or 3D shape, the position information can include two or more points in the presentation area. For example, a rectangular area can be represented by two points identifying the position of two opposite corners of the rectangular area. A line segment or curve segment can be represented by a start point and an end point of the line segment or curve segment.

In other examples, if the user interaction selects a subset of a presentation area the image or video content being an area or a 2D or 3D shape the associated position information can include a point and a characteristic measure of the respective area or a 2D or 3D shape. For instance, a square area can be represented by one of its corners and a length of a diagonal. A circular area can be represented by its center and its radius.

In some examples, the presentation area of the multimedia content item is a subarea of a total display area of a presentation device. For instance, the presentation area of the multimedia content item can be a portion of a web browser window. The position information can be relative position information relative to the presentation area. In addition, the relative position information can be normalized to a spatial extension of the presentation area. For example, a point can be associated with position information indicating that it is located at 90% of the width and 10% of the height of the presentation area. As the presentation area of the multimedia content item can be shifted over a total display area of a presentation device, this can be advantageous to make the position information independent from these shifts. In one example, the presentation area is rectangular and the origin of a coordinate system is at a corner (or at the center) of the rectangular presentation area.

For example, in FIG. 2 the presentation area is the first area for displaying video or image data 103 and an origin of the coordinate system can be in the upper left corner. The rectangular selection 114 associated with the a user interaction can then be associated with two coordinate pairs of the upper left and lower right corner of the rectangular selection associated with the user interaction. These two coordinate pairs form the position information associated with the user interaction in the example of FIG. 2.

The position information can include absolute length/distance measures. However, as video or image data of the multimedia content item often has a fixed resolution, this would lead to complications if the multimedia content item is presented on different presentation devices having different pixel sizes or display sizes. This issue can be addressed by representing the position information by a coordinate of the pixels of the display device the multimedia content item is presented on. Each point in the presentation area falls within the boundaries of one pixel of the display device. Therefore, a coordinate of this pixel can represent the point in the presentation area. Thus, each point is represented by two integers (usually, a coordinate system having axes parallel to the boundaries of the display device is chosen). Again, the position information can be relative to a predetermined point in the presentation area (e.g., a corner of a rectangular presentation area). The pixel of the presentation device displaying this origin can have, for instance, a pixel coordinate (0; 0). All positions, areas and 2D shapes in the presentation area can be described relative to this origin (e.g., the upper left corner of the rectangular selection of FIG. 2 can be represented by the pixel coordinate (150; 1000), the lower right corner by a pixel coordinate (200; 1100)). The representation of position information in pixel coordinates can be advantageous as in many systems the user interactions anyhow cannot be localized on a sub-pixel level. For example, if the pointer and/or input device is a computer mouse, the granularity of the cursor movement is usually limited by the pixel size of a display device. Furthermore, if the presentation area of the multimedia content item extends along a fixed number of pixels in both spatial directions, by using pixel coordinates user interactions on different presentation devices are comparable—shrinking an absolute extension of the presentation area due to a higher pitched display device leaves the pixel coordinate of a predetermined point in the display area unchanged.

In other examples, the position information is normalized to the extension of the presentation area of the multimedia content item on a presentation device. In this manner, position information associated with different user interactions on different presentation devices having different display sizes and display resolutions can be compared. In addition, the multimedia content item can be presented in different resolutions, either if a content provider offers the same content in different resolutions or if the resolution is changed by image/video processing techniques. Normalizing the position information to the extension of the presentation area of the multimedia content item on a presentation device can provide for comparable position information in these situations.

In FIGS. 5 and 6 sections of a presentation area of a multimedia content item is shown with different user interaction selected subsets of a presentation area. A correlation score can be calculated using position information associated with the different user interactions. This correlation score can be employed to estimate a probability that two different user feedbacks are related.

For example, in FIG. 5a, the subsets of the presentation area are rectangular areas 500a, 500b, and 500c. A user interaction with the multimedia content item to select a rectangular area has been described above. One of the rectangular areas 500a, 500b, and 500c is associated with a user interaction of a current user of an application for presenting a multimedia content item. For example, she/he wants to see if there are comments regarding the minus sign in the formula depicted on a slide of a presentation included in the multimedia content item. Two previous users gave feedback. The respective additional items including user feedback submitted by these previous users are associated with their respective selections of subsets of the presentation area 500a, 500c.

In one example, the application for presenting a multimedia content item to a user determines an overlap between the different rectangular areas 500b associated with the current user interaction and the rectangular areas 500a, 500c associated with previous user interactions. The correlation score is calculated based on the respective overlap. For instance, a higher overlap can translate into a higher correlation score. A higher correlation score can mean that the feedback of the previous user and question of the current user are related. In this manner, the application for presenting a multimedia content item can provide for an intuitive approach to detect related user interactions with the multimedia content item.

As described above, every subset of the presentation area associated with a user interaction is associated with position information. Therefore, the correlation score can be calculated by using the position information associated with a rectangular area 500b associated with a user interaction of a current user and the position information associated with a rectangular area 500a, 500c associated with a user interaction of the previous users.

In other examples, the areas selected by the user interactions have been other shapes than a rectangle. However, an overlap can be easily calculated also for non-rectangular shapes.

FIG. 5b shows a second example to calculate a correlation score between different user interactions. In this example, the user interactions selected different points 500d, 500e, and 500f in the presentation area. For instance, a user interaction of a current user of the application for presenting a multimedia content item can be selecting the point 501b. In this example, the application for presenting a multimedia content item to a user determines a distance between the point 500e associated with the current user interaction and the different points 500d, 500f associated with previous user interactions. The correlation score is calculated based on the respective distance. For instance, a higher distance can translate in a lower correlation score. Again, the correlation score is calculated using position information associated with every point.

FIG. 5c shows a third example to calculate a correlation score between different user interactions. In this example, the user interactions selected different lines segments 500g, 500h in the presentation area. For instance, a user interaction of a current user of the application for presenting a multimedia content item has drawn the line 500g. In this example, the application for presenting a multimedia content item to a user determines a distance between the start points and end points of the different lines (which can be the position information associated with this type of user interaction, as described above). A correlation score is calculated using these two distances.

In the examples described in connection with FIGS. 5a to 5c, all user interactions were associated with the same class of user interaction (e.g., selecting a rectangular subset, a point or a line segment). However, as depicted in FIG. 5d, different classes of user interactions can be correlated as well. In the example of FIG. 5d, a current user interaction is associated with a point 500k in the presentation area and two previous user interactions of users who gave feedback are associated with rectangular areas 500k, 500i. In order to correlate the different classes of user interactions, the rectangular areas can represented by a point (e.g., the center of gravity) and a distance between this point representing the area and the point 500k associated with the current user interaction can be determined. Alternatively, the point 500k associated with the current user interaction can be represented by an area (e.g., a rectangle) of predetermined size and the overlap between this area and the rectangular areas 500k, 500i associated with the previous user interactions can be determined to calculate the correlation score.

The correlation score can also be calculated based on different factors. For example, an overlap between two areas associated with two user interactions can be combined with a distance of their centers of gravity. In the example depicted in FIG. 6a, two rectangular subsets of the presentation area 600a, 600b associated with a current user interaction and a previous user interaction are shown. FIG. 6b shows a second situation also involving two rectangular subsets of the presentation area 600c, 600d associated with a current user interaction and a previous user interaction are shown. If the correlation score would be calculated only based on an overlap, in both situations an identical correlation score would be calculated. Therefore, the overlap value can be combined with a proximity value to determine the correlation score. For example, a proximity value can include a distance between the centers of gravities or between boundaries of two areas associated with two user interactions. A combined correlation score taking into account an overlap and a proximity value would yield a higher correlation in the situation depicted in FIG. 6a than in the situation depicted in FIG. 6b.

The application for presenting a multimedia content item to a user can use the correlation score to select one more additional items including user feedback are presented to a user in response to a user interaction with a multimedia content item being presented to the user. The correlation score is indicative of the relatedness of two user interactions.

In response to the correlation score meets a threshold value, an item including user feedback can be provided for display to the user. The threshold value can be a fixed threshold value set in the application for presenting a multimedia content item. Alternatively, the threshold value can be set dynamically depending on the number of available items including user feedback.

The correlation score can also be used, in response to a current user interaction, to determine a ranking of the additional items including user feedback. This facilitates selecting a predetermined number of highest ranks additional items including user feedback. In this case, the threshold is value is a dynamic threshold value determined by the n-th highest ranked items including user feedback, wherein n is the predetermined number of items to be presented. In addition, a second fixed threshold value can be used to secure a minimum correlation score. As the number of users giving feedback might be large this allows selecting user feedback for presentation that might be relevant to a current user of the application for presenting a multimedia content item. For example, in FIG. 2 three additional items including user feedback are presented.

In the previous examples, it was shown that user interactions can be associated with position information representing points or areas in a presentation area of the application for presenting a multimedia content item. In combination with this information, timing information representing a time in which the user interaction takes place (relative to a play time of the multimedia content item) can be associated with each user interaction. In this manner, a time spa between two user interactions can be used in addition to the spatial relationship of the user interactions to calculate a correlation score. For example, it only user interactions can be selected that happened within a predetermined time span from a time of a current user interaction during presentation of a multimedia content item can be selected. In some examples, the time span between two user interactions can be used exclusively to calculate the correlation score. For example, during presentation of a video two user interactions occurring at nearly the same time might be related.

In other examples, an image number in a series of images (e.g., in a presentation) can be associated with a user interaction. In this manner, only items including user feedback that relate to the same image as a current user interaction can be selected for presentation.

Besides the correlation score, the application for presenting a multimedia content item can also employ additional factors to determine a ranking of the one more additional items including user feedback. For example, users might have a possibility to rate the items including user feedback. In other examples, content of the items including user feedback can be taken into account. In still other examples, it can be taken into account whether the items including user feedback include attached image or video data. A ranking score can be calculated based on the correlation score and one or more of the additional factors. This ranking score can be used to select a predetermined number of highest ranked items including user feedback and presenting them to a current user.

The multimedia content items can be stored in a predetermined data format. For example, the multimedia content item can include three components. An audio track, image or video data and a text file documenting the activity of a pointer and/or input device of an author of the multimedia content item. When the multimedia content item is presented to a user, the application for presenting a multimedia content item presents the image or video data to the user and plays the audio track. In addition, the data characterizing the activity of the pointer and/or input device of the author is used to reconstruct a track of the author's pointer and/or input device and present this track on top of the presentation of the image or video data. In one example, a cursor of in input device is rendered during presentation of the multimedia content file.

Audio, video and activity of the pointer and/or input device information has to be synchronized to achieve a satisfying user experience. In one example, a master clock is derived from the audio track and during presentation of the multimedia content item, the track of the author's pointer and/or input device and the image or video data are synchronized to the master clock in each frame.

In one example, in a situation where the track of the author's pointer and/or input device cannot be drawn at a predetermined frame rate for a current frame, the application for presenting a multimedia content item calculates a number of frames to be skipped and then draws the track of the author's pointer and/or input device associated with a frame the number of frames to be skipped ahead of the current frame.

Subsequently, this operation is described in pseudo-code for an application executed in a browser environment:

IF(Browser updates according to set frame rate)
DRAW(Current frame)
ELSE
Calculate frameskip
DRAW(Current frame + frameskip)
END

If the browser is able to draw the track of the author's pointer and/or input device at a set frame rate, then the drawing operation is called. If this is not the case, a frameskip is calculated and the drawing operation is called on the current frame plus the frameskip that was calculated.

During recording of the multimedia content item by the author (see FIG. 3), the activity of the pointer and/or input device of the author might be documented in a text file at runtime. This might not always happen with a predetermined frame rate (e.g., 50 frames per second). This can lead to a track of the author's pointer and/or input device that is not synchronized with the audio track or the video and image data.

In one example, the application for presenting the multimedia content item calculates a stretch factor based on a total number of the plurality of position data points in the data file documenting the activity of the pointer and/or input device of the author and a length of the audio track and synchronizes drawing the track of the of the pointer and/or input device of the author and the audio track by correcting a timing of the track of the pointer and/or input device of the author using the stretch factor.

In one example, the stretch factor SF is calculated as (in pseudo-code):

SF=Math.round((1−audiotrack.duration*frame rate*2/mouse.length)*mouse.length),

where the variable “audiotrack.duration” stands for the length of the audio track and the variable “mouse.length” stands for the number of the plurality of position data points in the data file documenting the activity of the pointer and/or input device of the author.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. The computer storage medium can also be, or be included in, one or more separate physical components or media (e.g., multiple DVDs, disks, or other storage devices).

The operations described in this specification can be implemented as operations performed by a data processing apparatus on data stored on one or more computer-readable storage devices or received from other sources. The term “data processing apparatus” encompasses all kinds of apparatus, devices, and machines for processing data, including by way of example a programmable processor, a computer, a system on a chip, or multiple ones, or combinations, of the foregoing. The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes described in this specification can be performed by one or more programmable processors executing one or more computer programs to perform actions by operating on input data and generating output. Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices.

Devices suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

In a first aspect, a computer-implemented method includes obtaining first position information of a first user interaction with a multimedia content item that is presented at a first time to the first user in a presentation area on a first computer device, the first position information indicating the position where the first user interaction took place in the presentation area of the multimedia content item, obtaining, in response to obtaining the first position information, second position information of a second user interaction with the multimedia content item that was presented at a second time to a second user in a presentation area on a second computer device, the second time occurring before the first time, the second position information indicating the position where the second user interaction took place in the presentation area of the multimedia content item, calculating a correlation score that is indicative of the relatedness of the second user interaction to the first user interaction using the first position information and the second position information, in response to the correlation score meeting a threshold value, providing a first data set provided by the second user and associated with the first user interaction to the first user.

In one example of the computer-implemented method according to the first aspect, the first and/or second user interactions include a predetermined movement of a pointer in a presentation area of the multimedia content item.

In one example of the computer-implemented method according to the first aspect, the first and/or second user interactions include an action of an input device on a graphical user interface of a computer device, for example one selected from the group consisting of a computer mouse, a trackball, a finger, an input device for a touchscreen, a keyboard, an eye tracking system and a pointer.

In one example of the computer-implemented method according to the first aspect, the multimedia content item includes one selected from the group consisting of an image, a presentation or a video. The position information can include data characterizing a relative position where a respective user interaction took place relative to the multimedia content item or data characterizing a relative position where a respective user interaction took place relative to a display area of a computer device the multimedia content item is presented on. The relative position can be normalized to the spatial extensions of the presentation area.

In one example of the computer-implemented method according to the first aspect, the multimedia content item extends over a predetermined area or volume on a presentation area of a computer device the multimedia content item is presented on and the position information includes data characterizing a relative position where a respective user interaction took place inside the predetermined volume or area. The relative position can be normalized to the spatial extensions of the presentation area or volume. The computer-implemented method can include taking into account a size and/or a resolution of the display area of a computer device the multimedia content item is presented on.

In one example of the computer-implemented method according to the first aspect, the position information includes 2D or 3D position data of the respective user interaction on a display area of a computer device the multimedia content item is presented on. The position information can include a first coordinate pair or a first coordinate triplet of the respective user interaction on the display area of the computer device the multimedia content item is presented on. The first coordinate pair or the first coordinate triplet can indicate a pixel on the display area of the computer device the multimedia content item is presented on. The position information can include a second coordinate pair or a second coordinate triplet of the respective user interaction on a display area of the computer device the multimedia content item is presented on.

In one example of the computer-implemented method according to the first aspect, the user interaction selects a point on a display area of a computer device the multimedia content item is presented on.

In one example of the computer-implemented method according to the first aspect, the user interaction selects an area or volume on a display area of a computer device the multimedia content item is presented on. The area can be a rectangle, or an ellipsoid.

In one example of the computer-implemented method according to the first aspect, the user interaction selects two-dimensional shape on a display of a computer device the multimedia content item is presented on. The two dimensional shape can include a line segment or a curve segment.

In one example of the computer-implemented method according to the first aspect, calculating a correlation score using the first position information and the second position information includes determining a proximity value characterizing a distance of points associated with the first and second user interactions, respectively and calculating the correlation score based on the proximity value. The correlation score can increase with a decreasing distance of the distance between the points associated with the first and second user interactions, respectively. The correlation score can have a value corresponding to no correlation between the first and second user interactions if the distance of points associated with the first and second user interactions, respectively is larger than a threshold distance.

In one example of the computer-implemented method according to the first aspect, calculating a correlation score using the first position information and the second position information includes determining an overlap value characterizing an overlap of areas associated with the first and second user interactions, respectively and calculating the correlation score based on the proximity value. The correlation score can increase with an increasing overlap of the areas associated with the first and second user interactions, respectively. The correlation score can have a value corresponding to no correlation between the first and second user interactions if the overlap of the areas associated with the first and second user interactions, respectively is lower than a threshold overlap. The correlation score can be calculated based on a proximity value and an overlap value.

In one example of the computer-implemented method according to the first aspect, the first data is provided for presentation together with presenting the multimedia content item.

In one example of the computer-implemented method according to the first aspect, the first data set includes alphanumeric data and audio data. The first data set can additionally include image and/or video data.

In one example of the computer-implemented method according to the first aspect, the method further includes calculating a ranking score for the first data set provided by the second user and associated with the second user interaction based on the correlation score. The ranking score can be further calculated based on a user of the first data set. The correlation score can be further calculated based on information contained in the first data set. The method can further include obtaining a second ranking score for a second data set provided by a third user and associated with a third user interaction, and providing the first and second data sets and the first and second ranking data for transmission to the first user. The method can further include obtaining a second ranking score for a second data set provided by a third user and associated with a third user interaction, and providing the first and second data sets and the first and second ranking data for presentation to the second user together with the multimedia content item.

In one example of the computer-implemented method according to the first aspect, the first and/or second data sets are included in a plurality of data sets provided by a plurality of users and associated with a plurality user interactions with the multimedia content item, and the method further includes selecting a subset of the plurality of data sets based on ranking scores of the respective data sets, and providing the subset of data sets for presentation to the second user together with the multimedia content item.

In one example of the computer-implemented method according to the first aspect, the multimedia content item includes audio data, image/video data and data including information associated with previous users. The data can include information associated with previous users includes position information of previous user interactions with the multimedia content item which was presented to previous users.

In one example of the computer-implemented method according to the first aspect the second position information of a second user interaction with the multimedia content item is obtained from a repository including position information of a plurality of user interaction with the multimedia content item, and the first position information of a first user interaction with the multimedia content item is obtained from a user device on which the multimedia content item is being presented.

In one example of the computer-implemented method according to the first aspect the method can further include obtaining a third data set from the first user, and merging the third data set into the multimedia content item to generate an updated multimedia content item for presentation to further users.

In one example of the computer-implemented method according to the first aspect, the multimedia content item is adapted to be presented to the users in a browser environment.

In a second aspect, a computer-implemented method includes presenting a multimedia content item to a first user that is presented at a first time to the first user in a presentation area on a first computer device, monitoring first position information of a first user interaction with the multimedia content item, the first position information indicating the position where the first user interaction took place in the presentation area of the multimedia content item, providing the first position information to a computer system, obtaining a first data set provided by a second user and associated with a second user interaction with the multimedia content item that was presented at a second time to the second user in a presentation area on a second computer device, the second time occurring before the first time, the first data set being selected using a first correlation score that is indicative of the relatedness of the second user interaction to the first user interaction using the first position information and second position information, the second position information indicating the position where the second user interaction took place in the presentation area of the multimedia content item. The method can further include presenting the first data set to the second user while presenting the multimedia content item to the second user.

In one example of the computer-implemented method according to the second aspect, the method can further include obtaining a second data set provided by a third user and associated with a third user interaction with the multimedia content item, the second data set being selected using a second correlation score using the second position information and third position information of the third user interaction with the multimedia content item which was presented to the third user. The method can further include obtaining a first ranking score of the first data set and a second ranking score of the second data set, and presenting the first data set and the second data set to the second user in a ranked manner based on the first and second ranking scores while presenting the multimedia content item to the second user.

In one example of the computer-implemented method according to the second aspect, the multimedia content item and the first data set are presented on a 2D or 3D display.

In one example of the computer-implemented method according to the second aspect, the first and/or second data sets include alphanumeric data and audio data.

In one example of the computer-implemented method according to the second aspect, the first and/or second data sets include image and/or video data.

In one example of the computer-implemented method according to the second aspect, the multimedia content item includes one selected from the group consisting of an image, a digital presentation or a digital video.

In one example of the computer-implemented method according to the second aspect, the first and/or second user interactions are actions of a respective user in a presentation area of the multimedia content item. The first and/or second user interactions can include a predetermined movement of a pointer in a presentation area of the multimedia content item.

In one example of the computer-implemented method according to the second aspect, the first and/or second user interactions include an action of an input device for a computer device. The input device can include one selected from the group consisting of a computer mouse, a trackball, an input device for a touchscreen, a keyboard, an eye tracking system and a pointer.

In one example of the computer-implemented method according to the second aspect, the method further includes obtaining one or more additional data sets included in a plurality of data sets provided by a plurality of users and associated with a plurality user interaction with the multimedia content item, obtaining a respective ranking score associated with each of the one or more additional data sets, and presenting the first data set and the one and more additional data sets to the second user in a ranked fashion based on the ranking scores while presenting the multimedia content item to the first user.

In one example of the computer-implemented method according to the second aspect, the multimedia content item and the first data are presented to the first user in a browser environment.

In a second aspect, a computer-implemented method, includes presenting a multimedia content item to a second user, monitoring second position information of a second user interaction with the multimedia content item, providing the first position information to a computer system, and obtaining a first data set provided by a first user and associated with a first user interaction with the multimedia content item, the first data set being selected using a first correlation score using first position information and the second position information of the second user interaction with the multimedia content item.

In a third aspect, a computer-implemented method includes obtaining a presentation file or a video file having a predetermined play length, presenting the presentation file or the video file to a user, recording, during a first portion of the presentation of the presentation file or a video file, a first track of a user interaction on a display area of a computer device the presentation file or the video file are presented on, recording, during the first portion, a first audio signal, associating the first track and the first audio signal with the first portion of the presentation file or a video file to form a first portion of a multimedia content item, recording, during a second portion of the presentation of the presentation file or a video file other than the first portion, a second track of a user interaction on the display area of the computer device the presentation file or the video file are presented on, recording, during the second portion, a second audio signal, associating the second track and the second audio signal with the second portion of the presentation file or a video file to form a second portion of a multimedia content item, displaying a first graphical item representing the first portion of a multimedia content item and a second graphical item representing the second portion of a multimedia content item, receiving a user interaction with the first and second graphical items, and changing the order of the first and second portions of the resultant multimedia file upon the user interaction.

In one example of the computer-implemented method according to the third aspect, the first and second graphical items have the form of first and second progress bars, each having a length that represents a duration of the respective portion compared to a total length of the presentation file or a video file.

In one example of the computer-implemented method according to the fourth aspect the presentation file or the video file are presented to the user in a web-browser environment, and the first and second graphical items are presented to the user in a web-browser environment. In addition, control elements to start and stop recording the tracks of the input devices and the audio files can be presented to the user in a web-browser environment.

In a fourth aspect, a computer-implemented method includes obtaining a multimedia content item including a first track of a user interaction, an audio file and a presentation file or a video file, setting a master clock derived from the audio file, presenting the multimedia content item to a user including drawing the track of the user interaction on top of the presentation file or the video file and playing the audio file, where during presentation of the multimedia content item, the track of the user interaction and the presentation file or the video file are synchronized to the master clock in each frame.

In one example of the computer-implemented method according to the fourth aspect, the multimedia content item is presented to the user with a fixed frame rate.

In one example of the computer-implemented method according to the fourth aspect, in a situation where the track of the user interaction cannot be drawn at a predetermined frame rate for a current frame the method further includes calculating a number of frames to be skipped, and drawing the track of the user interaction associated with a frame the number of frames to be skipped ahead of the current frame.

In one example of the computer-implemented method according to the fourth aspect the track of the user interaction is stored data file including a plurality of position data points, each associated with a time value, the method further includes calculating a stretch factor base on a total number of the plurality of position data points in the data file for the track of the user interaction and a length of the audio file, and synchronizing the drawing track of the user interaction and the audio file by correcting a timing of the track of the user interaction using the stretch factor.

In one example of the computer-implemented method according to the fourth aspect correcting a timing of the track of the user interaction includes multiplying each time mark associated with the plurality of position data points by the stretch factor.

In one example of the computer-implemented method according to the fourth aspect the multimedia content item is presented in a browser environment.

A computer readable medium including instructions which when loaded to a computer system can cause the computer system to execute the method steps of any methods according to the first to fourth aspect.

A computer device including a processor and a storage device can be configured to perform the steps of any of methods according to the first to fourth aspect.

A computer device including a processor, as display and an input device can be configured to perform the steps of any of methods according to the first to fourth aspect.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method, comprising:
obtaining first position information of a first user interaction with a multimedia content item that is presented at a first time to the first user in a presentation area on a first computer device, the first position information indicating the position where the first user interaction took place in the presentation area of the multimedia content item;
obtaining, in response to obtaining the first position information, second position information of a second user interaction with the multimedia content item that was presented at a second time to a second user in a presentation area on a second computer device, the second time occurring before the first time, the second position information indicating the position where the second user interaction took place in the presentation area of the multimedia content item;
calculating a correlation score that is indicative of the relatedness of the second user interaction to the first user interaction using the first position information and the second position information;
in response to the correlation score meeting a threshold value, providing a first data set provided by the second user and associated with the first user interaction to the first user.

2. The computer-implemented method of claim 1, wherein the first and/or second user interactions include a predetermined movement of a pointer in a presentation area of the multimedia content item.

3. The computer-implemented method of claim 1, wherein the multimedia content item extends over a predetermined area or volume on a presentation area of a computer device the multimedia content item is presented on and the position information includes data characterizing a relative position where a respective user interaction took place inside the predetermined volume or area.

4. The computer-implemented method of claim 3, further including taking into account a size and/or a resolution of the display area of a computer device the multimedia content item is presented on.

5. The computer-implemented method of claim 1, wherein the position information includes a second coordinate pair or a second coordinate triplet of the respective user interaction on a display area of the computer device the multimedia content item is presented on.

6. The computer-implemented method of claim 1, wherein the user interaction selects a point, an area or volume on a presentation area of a computer device the multimedia content item is presented on.

7. The computer-implemented method of claim 1, wherein the user interaction selects two-dimensional shape on a display of a computer device the multimedia content item is presented on.

8. The computer-implemented method of claim 1, wherein calculating a correlation score using the first position information and the second position information includes:
determining a proximity value characterizing a distance of points associated with the first and second user interactions, respectively; and
calculating the correlation score based on the proximity value.

9. The computer-implemented method of claim 1, wherein calculating a correlation score using the first position information and the second position information includes:
determining an overlap value characterizing an overlap of areas associated with the first and second user interactions, respectively; and
calculating the correlation score based on the overlap value.

10. The computer-implemented method of claim 9, further comprising:
determining a proximity value characterizing a distance of points associated with the first and second user interactions, respectively, wherein the correlation score is calculated based on the proximity value and the overlap value.

11. The computer-implemented method of claim 1, further comprising:
calculating a ranking score for the first data set provided by the second user and associated with the second user interaction based on the correlation score.

12. The computer-implemented method of claim 11, wherein the ranking score is further calculated based on a user ranking of the first data set.

13. The computer-implemented method of anyone of claims 12, wherein the correlation score further is calculated based on information contained in the first data set.

14. The computer-implemented method of claim 11, further comprising:
obtaining a second ranking score for a second data set provided by a third user and associated with a third user interaction; and
providing the first and second data sets and the first and second ranking data for to the first user.

15. The computer implanted method of claim 14, wherein the first and/or second data sets are included in a plurality of data sets provided by a plurality of users and associated with a plurality user interactions with the multimedia content item, the method further comprising:
selecting a subset of the plurality of data sets based on ranking scores of the respective data sets; and
providing the subset of data sets for presentation to the second user together with the multimedia content item.

16. The computer-implemented method of claim 1, wherein first position information of a second user interaction with the multimedia content item is obtained from a repository including position information of a plurality of user interaction with the multimedia content item, and
wherein the first position information of a first user interaction with the multimedia content item is obtained from a user device on which the multimedia content item is being presented.

17. The computer-implemented method of claim 1, further including:
obtaining a third data set from the first user; and
merging the third data set into the multimedia content item to generate an updated multimedia content item for presentation to further users.

18. The computer-implemented method of claim 1, wherein the multimedia content item is adapted to be presented to the users in a browser environment.

19. A computer-implemented method, comprising:
presenting a multimedia content item to a first user that is presented at a first time to the first user in a presentation area on a first computer device;
monitoring first position information of a first user interaction with the multimedia content item, the first position information indicating the position where the first user interaction took place in the presentation area of the multimedia content item;
providing the first position information to a computer system;
obtaining a first data set provided by a second user and associated with a second user interaction with the multimedia content item that was presented at a second time to the second user in a presentation area on a second computer device, the second time occurring before the first time, the first data set being selected using a first correlation score that is indicative of the relatedness of the second user interaction to the first user interaction using the first position information and second position information, the second position information indicating the position where the second user interaction took place in the presentation area of the multimedia content item.

20. A computer system configured to:
obtain first position information of a first user interaction with a multimedia content item that is presented at a first time to the first user in a presentation area on a first computer device, the first position information indicating the position where the first user interaction took place in the presentation area of the multimedia content item;
obtain, in response to obtaining the first position information, second position information of a second user interaction with the multimedia content item that was presented at a second time to a second user in a presentation area on a second computer device, the second time occurring before the first time, the second position information indicating the position where the second user interaction took place in the presentation area of the multimedia content item;
calculate a correlation score that is indicative of the relatedness of the second user interaction to the first user interaction using the first position information and the second position information;
in response to the correlation score meeting a threshold value, provide a first data set provided by the second user and associated with the first user interaction to the first user.
